(19) United States
(12) Patent Application Publication
(10) Pub. No.: US 2008/0196980 A1
(43) Pub. Date: Aug. 21, 2008

(54) Elevator System

(76) Inventors: Atsushi Yamada, Narita-City (JP); Natsuki Kawamura, Narita-shi (JP)

Correspondence Address: CARLSON GASKEY & OLDS, 400 W MAPLE STE 350, BIRMINGHAM, MI, 48009, US

(21) Appl. No.: 11/915,398

(22) PCT Filed: Jun. 7, 2006
(86) PCT No.: PCT/US2006/022149

§ 371 Date: Nov. 26, 2007

(30) Foreign Application Priority Data
Jun. 9, 2005 (JP) 2005-168946

(51) Int. Cl. B66B 3/00

(52) U.S. Cl. 187/391

(57) ABSTRACT

An elevator system that includes a film sensor is arranged on the inner surface of a wall panel in the elevator car, and a prescribed control operation is performed when the detection output of the film sensor exceeds a prescribed level. This system allows for a quick response to an emergency at low cost, and can be used in a variety of locations without influencing the layout and design of the elevator car.

### TECHNICAL FIELD

The present invention pertains to a type of elevator system that can respond quickly in case of an emergency in the elevator.

### BACKGROUND OF THE INVENTION

Japanese Patent Application No. 2001-2339 describes a method for detecting an emergency in an elevator. Specifically, an emergency button provided in the elevator car is pressed and held for a prescribed time as a means for notifying an external monitoring center of the occurrence of the emergency. For instance, referring to FIG. 4 an emergency button 1 is arranged on an operating panel 3 in an elevator car 2. However, the location where the emergency button 1 can be used is limited to operating panel 3. Also, the placement of the emergency button 1 influences the layout and design of operating panel 3 in the car and it is difficult to change the design once the button 1 is installed on the panel 3. In addition, the installation of emergency button 1 is expensive. In addition, when the emergency button is pressed and held for a prescribed time or longer, for example, the status of the emergency is checked at the monitoring center and the staff stops the elevator at the nearest floor or takes other control measures. Consequently, the response to the emergency can be slow and this is not desirable.

Another method for detecting an emergency situation in an elevator from the standpoint of security is to have a monitoring camera always on in the elevator car. However, when the monitoring camera is kept on all the time as aforementioned, the operating cost is high, and there are many man-hours that are needed for storage and checking the recorded video information.

### SUMMARY OF THE INVENTION

In order to solve the aforementioned problem, an exemplary embodiment of the invention provides a type of elevator system that includes a film sensor arranged on an inner surface of the wall panel in the elevator car, and a prescribed control operation is performed when the detection output of the film sensor exceeds a prescribed level. This system allows for a quick response to an emergency at low cost, and can be used in a variety of locations without influencing the layout and design of the elevator car.

### BRIEF DESCRIPTION OF THE DRAWINGS

Embodiments of the present invention will be explained below with reference to figures, but the present invention is not limited to the embodiment below.

FIG. 1 is an oblique view of the elevator car illustrating an example of installation of the EMFi sheet.

FIG. 2 is a block diagram illustrating an embodiment of the present invention.

FIG. 3 is a cross section illustrating an example of the electronic/mechanical film sensor of the present invention.

FIG. 4 is a diagram illustrating an example of the emergency button arrangement in an elevator system in the prior art.

### DETAILED DESCRIPTION

In the following, an explanation will be given regarding the embodiment of the present invention, with reference to figures. However, the present invention is not limited to the following embodiment.

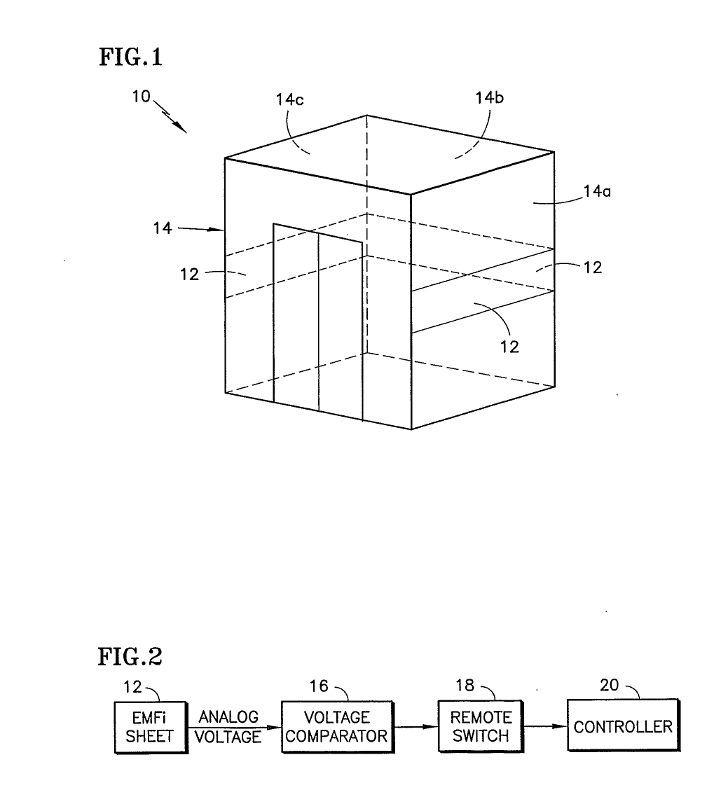

FIG. 1 illustrates an elevator system 10 includes a film sensor 12 arranged on the surface of the wall panel in the elevator car 14. In an exemplary embodiment, the film sensor 12 is an EMFi sheet, which is a type of an electronic/mechanical film sensor, that is applied in ribbon form to a surface of peripheral wall sides 14a, 14b, and 14c, other than the door portion, of elevator car at about 1-1.5 m above the floor. That is, EMFi sheet 12 is directly bonded to the steel sheets of car peripheral walls 14a-14c from outside of the elevator car. The EMFi sheet 12 is a sensor that can sense vibration or impact from variations in pressure. For example, it can be installed on the floor of an elderly person's home as a sensor for detecting the elderly person walking around in the room. Thus, in the event of an emergency, the passenger may produce vibration or impacts by pounding on the wall in elevator car 14, and EMFi sheet 12 detects the pressure generated by the vibration or impact. Also, even when vibration is caused at a location outside the region where EMFi sheet 12 is attached, it is still possible to detect vibration within a certain proximity.

Referring to FIG. 2, which is a block diagram illustrating the main portion of the exemplary embodiment, the EMFi sheet 12 is attached to the outside wall of the elevator car for detecting vibration and impacts. The detection output of the EMFi sheet 12, an analog voltage a, is input to a voltage comparator 16 for comparison with a prescribed threshold voltage (in practice, because the output voltage of said EMFi sheet 12 is low, it is amplified with an appropriate amplifier or the like and then compared with the threshold voltage).

In particular, as explained above, in the event of an emergency, the passenger may apply vibration or impact by pounding the wall of elevator car, and the EMFi sheet will detect the pressure generated by the vibration or impact. The EMFi sheet 12 then outputs an analog voltage. At the instant when the detected analog voltage a exceeds the threshold voltage, the output of voltage comparator 16 turns ON remote switch (RS) 18, and the vibration detection signal is input to an elevator controller 20. Accordingly, the operation of the monitoring camera in the elevator car is started, so that an alarm siren is turned ON, and elevator car is stopped at the nearest floor and the door is opened.

In the following, an explanation will be given of an example of the control performed by the controller 20 when a vibration detection signal is input to elevator controller 20 shown in FIG. 2.

(1) The operation of the monitoring camera is started.

(2) At the same time, an alarm is turned ON, and an announcement is made over a loudspeaker to notify the passengers of the emergency condition.

(3) The elevator is stopped at the nearest floor and the door is opened.

(4) The door is kept open for a length of time (about 15 sec) greater than the normal case, and after the open door time is reached, the door is closed.

(5) The elevator returns to the normal operating mode.

(6) The alarm, loudspeaker and monitoring camera are turned OFF.

As explained above, only when the detection output of EMFi sheet 12 exceeds a prescribed output level, such as when the passenger in the elevator car pounds the walls 14a, 14b, and 14c of elevator car 14 to cause vibration in the event of an emergency will the monitoring camera in the elevator car be operated.

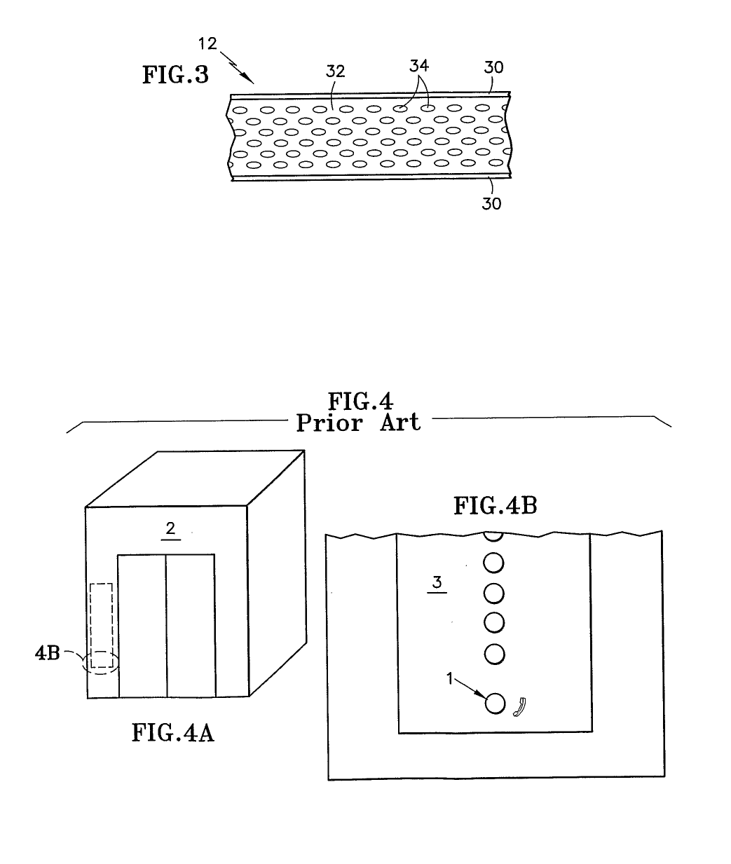

The EMFi sheet was developed by the Chemical Department of the National Technical Development Center of Finland in the early 1990s. As shown in FIG. 3, it is prepared by applying an electroconductive film (electrode sheet) 30 to the two surfaces of an element feed material 32 made of a polypropylene sheet. To create the element feed material 32, a charge is applied to a polypropylene sheet (with a thickness of, for example, about 30 μm) having numerous cavities (bubbles, with an average diameter of, for example, 1 μm) 34 formed in it, so that a charge is formed in the bubbles 34. For example, the electroconductive film 30 may be prepared by coating one surface of a polyethylene film with an electroconductive paste by means of screen printing.

In an EMFi sheet 12 with this constitution, when a force (pressure) or vibration is applied, charge migrates in proportion to the force (pressure) or vibration, so that a potential difference is developed at the electroconductive films 30 on the two sides of element feed material 32.

This type of EMFi sheet is very inexpensive. Also, because the EMFi sheet is manufactured in roll form, there is a high degree of freedom in the longitudinal direction, and it can be installed easily in the elevator car. Consequently, the installation cost can be reduced. In addition, it has other characteristic features, such as a very wide additive load range and a very wide frequency response.

The advantages of the elevator system 10 are that the operating cost can be significantly reduced. In addition, because a monitoring camera is not always required to be ON, the video recording time can be shortened, and storage and checking of the recorded video information can be significantly simplified. Moreover, operation of the monitoring camera in the elevator car allows evidence to be collected for any purpose.

Further, even in the event of malfunction of EMFi sheet 12, it is possible to check the situation with the monitoring camera in the elevator car. Consequently, it is possible to adjust the sensitivity of EMFi sheet 12 (film sensor).

In the event of an emergency, it is possible to make the elevator car stop and its door open at the nearest floor in a reliable and immediate way by simply applying a vibration or impact higher than the prescribed threshold value to EMFi sheet 12 (film sensor). Consequently, the safety of the passengers can be quickly guaranteed, and it is possible to keep the passengers from being trapped in the elevator car for a long period of time.

Also, the installation location of the EMFi sheet 12 is not limited to that shown in FIG. 1. The EMFi sheet 12 may be install anywhere as long as it is on the inner surface of the wall panel of the elevator car. Also, the size of EMFi sheet 12 is not limited to the size shown in FIG. 1. The size can be larger or smaller than the size shown.

Accordingly, because the film sensor is provided on the wall panel in the elevator car, it has no influence on the layout and design of the existing elevator car operating panel. Also, after installation of the film sensor of the present invention, it is possible to change the layout and design of said operating panel without any problems. The film sensor detects the force of vibration, impact, etc., yet because it is placed on the inner surface of the wall panel in the elevator car, no malfunction takes place even when the passengers in the elevator car make contact with the surface of the wall panel. In addition, because the film sensor is turned ON by the force of vibration, impact, etc., it can be used over a wide range in the elevator without being limited in its location site as was the case for the emergency button in the prior art.

Moreover, because the electronic/mechanical film sensor is inexpensive, the cost can be reduced. For example, the price is only half that of the acceleration sensor in the prior art. Also, according to the present invention, one may simply bond the electronic/mechanical film sensor to the wall panel in the elevator car, such as directly on the inner surface of a steel sheet. Consequently, compared with the existing sensor, installation is easier and the installation cost can be reduced.

Additionally, because the electronic/mechanical film sensor is processed and manufactured in roll form, there is great freedom in the longitudinal direction. Consequently, it is easy to install it on the inner surface of the wall panel in the elevator car, and the installation cost can be reduced.

Also, the electronic/mechanical film sensor has a characteristic feature that the additive load range, that is, the range in which a load change is detected, is extremely wide. Consequently, it is possible to detect forces of vibration and impact applied to the elevator car over a wide range, and the detection sensitivity is very high.

Only when the detection output of the film sensor exceeds a prescribed level, such as when the passengers in the elevator car beat on the wall panel in the event of an emergency to cause vibration, is the monitoring camera in the elevator car turned ON. Consequently, the operating cost can be reduced significantly. Also, because the monitoring camera is not always ON, the video recording time can be shortened, and storage and checking of the video recording information can be significantly simplified. Also, when the monitoring camera in the elevator car is turned ON, it is possible to collect evidence for any purpose. Also, even in case of malfunction of the film sensor, it is still possible to check the elevator car with the monitoring camera. Consequently, it is possible to adjust the sensitivity of the film sensor.

In the event of emergency, it is possible to stop the elevator car at the nearest floor and open the door immediately and reliably simply by applying a vibration or impact higher than a prescribed threshold value to the film sensor. As a result, the safety of the passengers can be guaranteed quickly, and it is possible to keep the passengers from being trapped in the elevator car for an extended period.

In summary, the elevator system has a low cost and can quickly respond to an emergency, with a wide range of application that does not affect the layout and design of the elevator car.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A type of elevator system comprising:
a film sensor arranged on an inner surface of a wall panel in an elevator car; and
a prescribed elevator car control is performed when a detection output of said film sensor exceeds a prescribed level.

2. The elevator system described in claim 1 wherein said film sensor is made of an electronic/mechanical film sensor.

3. The elevator system described in claim 1 wherein said prescribed control starts an operation of a monitoring camera in the elevator car.

4. The elevator system described in claim 1 wherein said prescribed control stops the elevator car at the nearest floor and opens the door.

5. The elevator system described in claim 1 wherein said film sensor is adapted to detect a vibration, and said film sensor is adapted to output an analog voltage in response to a vibration.

6. The elevator system described in claim 5 further comprising a voltage comparator arranged to receive the analog voltage and compare the analog voltage to a prescribed threshold voltage.

7. The elevator system described in claim 1 further comprising a controller adapted to receive a vibration detection signal.

8. A method of controlling an elevator car, the method comprising:
receiving a vibration detection signal, wherein the vibration detection signal is produced from detecting a vibration at a film sensor at the elevator car; and
stopping the elevator car at a next floor.

9. The method described in claim 8, further comprising: starting a monitoring camera.

10. The method described in claim 8, further comprising: making an announcement over a loudspeaker about an emergency condition.

11. The method described in claim 8, further comprising: keeping an elevator door open for a prescribed length of time; and closing the elevator door.

12. The method described in claim 8, further comprising:
returning the elevator to a normal operating mode.
